(19) United States
(12) Patent Application Publication
(10) Pub. No.: US 2026/0111849 A1
(43) Pub. Date: Apr. 23, 2026

(54) MANAGEMENT SERVER THAT PERFORMS EMPLOYEE ATTENDANCE MANAGEMENT BY LINKING WITH WIRELESS ROUTER EQUIPMENT CONNECTED TO THE NETWORK, AND OPERATING METHOD THEREOF

(71) Applicant: MY ALL CO., LTD., Seoul (KR)

(72) Inventors: Ok Chae KIM, Seoul (KR); Changsoo YU, Hwaseong-si (KR)

(73) Assignee: MY ALL CO., LTD., Seoul (KR)

(21) Appl. No.: 19/322,530

(22) Filed: Sep. 8, 2025

(30) Foreign Application Priority Data
Oct. 21, 2024 (KR) 10-2024-0143901

(51) Int. Cl. G06Q 10/1091; G07C 1/10; H04L 67/54

(52) U.S. Cl. CPC G06Q 10/1091; G07C 1/10; H04L 67/54

(57) ABSTRACT

According to the present disclosure, it is possible to support a manager in performing attendance management of employees more easily and conveniently by providing a management server that performs employee attendance management by linking with wireless router equipment connected to a network. and an operating method thereof.

### CROSS-REFERENCE TO RELATED APPLICATIONS

This application claims priority to and the benefit of Korean Patent Application No. 10-2024-0143901 filed in the Korean Intellectual Property Office on Oct. 21, 2024, the entire contents of which are incorporated herein by reference.

### TECHNICAL FIELD

The present disclosure relates to a management server that performs employee attendance management by linking with wireless router equipment connected to a network, and an operating method thereof.

### BACKGROUND ART

In recent years, as wireless router equipment capable of wireless communication, such as a wireless router, has become widespread, a service capable of providing various functions in a small space using such wireless router equipment has been released.

Among services using such wireless router equipment, introduction of a service capable of performing attendance management of employees in a workplace can be considered.

Specifically, as the spread of electronic terminals capable of wireless communication has become more active in recent years, it is possible to consider introducing a system for checking whether employees have come to work or left work at the workplace or are staying in the workplace during working hours by confirming whether the electronic terminals possessed by the employees are connected to wireless router equipment installed in the workplace.

Since the wireless router equipment has a predetermined coverage for wireless communication, and therefore the electronic terminal needs to approach a location within the communication coverage of the wireless router equipment in order to access the wireless router equipment, installation of a predetermined wireless router equipment within the workplace enables monitoring whether employees carrying a predetermined electronic terminal are located within the workplace through the wireless router equipment.

Therefore, there is a need for research on a system technology capable of performing attendance management of employees holding the electronic terminal by linking with predetermined wireless router equipment installed in the workplace.

### SUMMARY OF THE INVENTION

The present disclosure has been made in an effort to support a manager in performing attendance management of employees more easily and conveniently by providing a management server that performs employee attendance management by linking with wireless router equipment connected to a network, and an operating method thereof.

An exemplary embodiment of the present disclosure provides a management server that performs employee attendance management by linking with wireless router equipment connected to a network, which includes: an employee database storing employee identification information of each of a plurality of employees and device identification information of an electronic terminal held by each of the plurality of employees to correspond to each other; an acquisition event generator generating, when a predetermined work start time is reached, an acquisition event for acquiring device identification information of electronic terminals connected to the wireless router equipment at a predetermined first time interval starting from the work start time up to a predetermined work end time; a confirmer acquiring the device identification information of the electronic terminals connected to the wireless router equipment from the wireless router equipment when the acquisition event is generated through the acquisition event generator at any one time point, and then confirming whether there is device identification information matching the device identification information acquired from the wireless router equipment among the device identification information on the electronic terminals of the plurality of employees; an extractor extracting, when it is confirmed that at least one device identification information is present as information matching the device identification information acquired from the wireless router equipment among the device identification information of the electronic terminals of the plurality of employees as a result of the confirmation by the confirmer, at least one employee identification information stored to correspond to the at least one device identification information from the employee database; and an information storage processor generating, when the at least one employee identification information is extracted, an attendance confirmation table in which the at least one employee identification information is recorded, generating date/time information at time point when the acquisition event occurs, and then storing the date/time information and the attendance confirmation table on a predetermined attendance history database to correspond to each other.

Further, another embodiment of the present disclosure provides an operating method of a management server that performs employee attendance management by linking with wireless router equipment connected to a network, which includes: maintaining an employee database storing employee identification information of each of a plurality of employees and device identification information of an electronic terminal held by each of the plurality of employees to correspond to each other; generating, when a predetermined work start time is reached, an acquisition event for acquiring device identification information of electronic terminals connected to the wireless router equipment at a predetermined first time interval starting from the work start time up to a predetermined work end time; acquiring the device identification information of the electronic terminals connected to the wireless router equipment from the wireless router equipment when the acquisition event is generated through the generating of the acquisition event at any one time point, and then confirming whether there is device identification information matching the device identification information acquired from the wireless router equipment among the device identification information on the electronic terminals of the plurality of employees; extracting, when it is confirmed that at least one device identification information is present as information matching the device identification information acquired from the wireless router equipment among the device identification information of the electronic terminals of the plurality of employees as a result of the confirmation in the confirming, at least one employee identification information stored in correspondence with the at least one device identification information from the employee database; and generating, when the at least one employee identification information is extracted, an attendance confirmation table in which the at least one employee identification information is recorded, generating date/time information at time point when the acquisition event occurs, and then storing the date/time information and the attendance confirmation table on a predetermined attendance history database to correspond to each other.

According to exemplary embodiments of the present disclosure, it is possible to support a manager in performing attendance management of employees more easily and conveniently by providing a management server that performs employee attendance management by linking with wireless router equipment connected to a network, and an operating method thereof.

### BRIEF DESCRIPTION OF THE DRAWINGS

FIG. 1 is a diagram illustrating a structure of a management server according to an exemplary embodiment of the present disclosure.

FIG. 2 is a flowchart illustrating an operating method of a management server according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising” n will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of the accompanying flowchart may be appreciated as meaning computer program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable exemplary embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

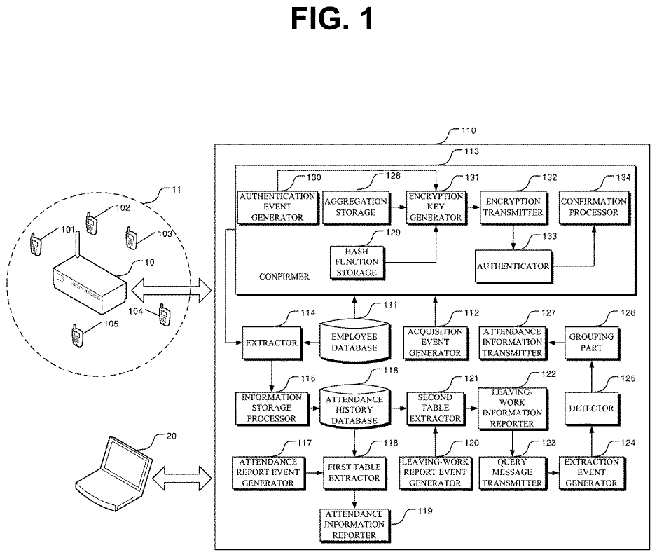

FIG. 1 is a diagram illustrating a structure of a management server according to an exemplary embodiment of the present disclosure.

Referring to FIG. 1, a management server 110 according to the present disclosure is a device that performs attendance management of employees by linking with a wireless router equipment 10 connected by a network, and includes an employee database 111, an acquisition event generator 112, a confirmer 113, an extractor 114, and an information storage processor 115.

Here, the wireless router equipment 10 is a device installed in a predetermined workplace, and has a predetermined communication coverage 11 for wireless communication. Therefore, electronic terminals that access the communication coverage 11 may be connect to the wireless router equipment 10, and at this time, when the wireless router equipment 10 is connected to an electronic terminal located in the communication coverage 11, the wireless router equipment 10 is configured to obtain device identification information of the electronic terminal from the electronic terminal. In addition, since the wireless router equipment 10 is connected to the management server 110 of the present disclosure through a wired/wireless network, the wireless router equipment 10 may transmit and receive data to and from the management server 110.

In such a situation, the employee database 111 stores employee identification information of each of a plurality of employees and device identification information of the electronic terminal carried by each of the plurality of employees in correspondence with each other.

Here, the employee identification information refers to unique information for identifying each employee, such as a name, a mobile phone number, a resident registration number, and an ID of each employee, and the device identification information refers to specific information for identifying each device, such as a Media Access Control (MAC) address, a mobile phone numbers, and an International Mobile Equipment Identity (IMEI) allocated to each electronic terminal.

In this regard, information may be stored in the employee database 111 as shown in Table 1 below.

TABLE 1

| Employee identification | Device identification information |
|---|---|
| information of plurality | of electronic terminals of plurality |
| of employees | of employees |
| Employee identification | Device identification information 1 |
| information 1 | |
| Employee identification | Device identification information 2 |
| information 2 | |
| Employee identification | Device identification information 3 |
| information 3 | |
| . . . | . . . |

The acquisition event generator 112 generates an acquisition event for acquiring device identification information of electronic terminals connected to the wireless router equipment 10 at a predetermined first time interval, when a predetermined work start time is reached, from the work start time up to a predetermined work end time.

For example, when the work start time is ates an acquisition event for acquiring device identification information of electronic terminals connected 112 may generate an acquisition event for acquiring the device identification information of the electronic terminals connected to the wireless router equipment 10 at an interval of “30 minutes” starting from “9 a.m.” until “6 p.m.” when a current time reaches “9 a.m.”.

The confirmer 113 acquires the device identification information of the electronic terminals connected to the wireless router 10 from the wireless router equipment 10 when the acquisition event occurs through the acquisition event generator 112 at any one time point, and then confirms whether there is device identification information matching the device identification information acquired from the wireless router equipment 10 among the device identification information on the electronic terminals of the plurality of employees.

In this regard, it is assumed that the acquisition event occurs through the acquisition event generator 112 as the current time becomes ition e″.

In this case, when electronic terminals of employees who access the communication coverage 11 of the wireless router equipment 10 are referred to as electronic terminals 101, 102, 103. 104, and 105 denoted by reference numerals 101, 102. 103, 104, and 105, the electronic terminals 101, 102, 103, 104, and 105 may access the wireless route equipment 10.

In this case, the confirmer 113 may acquire device identification information of the electronic terminals 101, 102, 103, 104, and 105 which access the wireless router equipment 10 from the wireless router equipment 10 because the acquisition event occurs.

When the device identification information of the electronic terminals 101, 102, 103, 104, and 105 is referred to as 03, 104, and 105 which access the wireless router equipment 10 from the wireless router equipment information 4, device identification information 7, and device identification information 10″, respectively, the confirmer 113 may confirm whether there is device identification information matching the device identification information “device identification data 1, device identification data 3, device identification data 4, device identification data 7, and device identification data 10 acquired from the wireless router equipment 10 among the device identification information for the electronic terminals of the plurality of employees stored in the employee database 111 as shown in Table 1.

When it is confirmed that at least one device identification information is present as information matching the device identification information acquired from the wireless router equipment 10 among the device identification information of the electronic terminals of the plurality of employees as a result of the confirmation by the confirmer 113, the extractor 114 extracts the at least one employee identification information stored in correspondence with the at least one device identification information from the employee database 111.

In this regard, as in the above-described example, when the device identification information acquired from the wireless router equipment 10 is referred to as “device identification information 1, device identification information 3, device identification information 4, device identification information 7, and device identification information 10”, and it is confirmed that “device identification information 1, device identification information 3, device identification information 4, and device identification information 7” are present as information matching the device identification information acquired from the wireless router equipment 10 among the device identification information of the electronic terminals of the plurality of employees as the confirmation result of the confirmer 113, the extractor 114 may extract employee identification information stored to correspond to “device identification information 1, device identification information 3, device identification information 4, and device identification information 7”, respectively from the employee database 111.

For example, when the employ identification information corresponding to “device identification information 1” is “employee identification information 1”, the employ identification information corresponding to “device identification information 3” is “employee identification information 3”, the employ identification information corresponding to “device identification information 4” is “employee identification information 4”, and the employ identification information corresponding to “device identification information 7” is “employee identification information 7”, the extractor 114 may extract “employee identification information 1, employee identification information 3, employee identification information 4, and employee identification information 7” from the employee database 111.

When the at least one employee identification information is extracted, the information storage processor 115 generates an attendance confirmation table in which the at least one employee identification information is recorded, generates date/time information at time point when the acquisition event occurs, and then stores the date/time information and the attendance confirmation table on a predetermined attendance history database 116 to correspond to each other.

In this regard, as in the above-described example, when e confirmation table in which mation 1, employee identification information 3, employee identification information 4, and employee identification information 7″ are extracted by the extractor 114, the information storage processor 115 may generate an attendance confirmation table in which “employee identification information 1, employee identification information 3, employee identification information 4, and employee identification information 7” are recorded, as shown in Table 2 below.

TABLE 2
Employee identification information

Employee identification information 1
Employee identification information 3
Employee identification information 4
Employee identification information 7

Then, the storage processor 115 may generate date/time information at the time point at which the acquisition event occurs as “9:00 a.m. on Oct. 15, 2024” and then store the date/time information and the attendance confirmation table to correspond to each other on the attendance history database 116.

According to the scheme described so far, the management server 110 of the present disclosure may repeatedly perform the operations of the acquisition event generator 112, the confirmer 113, the extractor 114, and the information storage processor 115 at the first time interval starting from the work start time up to the work end time. Accordingly, each time the first time elapses from the work start time up to the work end time, the management server 100 of the present disclosure may hold the electronic terminal connected to the wireless router equipment 10 and generate the attendance confirmation table in which the employee identification information of the employees is recorded, and store the attendance confirmation table on the attendance history database 116 together with the date/time information at a time point when each attendance confirmation table is generated. Moreover, the management server 110 may perform the work of generating the attendance confirmation table every day. As a result, the attendance history database 116 may store attendance confirmation tables as shown in Table 3 below.

TABLE 3

| Date/time information | Attendance confirmation tables |
|---|---|
| . . . | . . . |
| 5:30 p.m. on Oct. 14, 2024 | Attendance confirmation table A |
| 6:00 p.m. on Oct. 14, 2024 | Attendance confirmation table B |
| 9:00 a.m. on Oct. 15, 2024 | Attendance confirmation table 1 |
| 9:20 a.m. on Oct. 15, 2024 | Attendance confirmation table 2 |
| 9:50 a.m. on Oct. 15, 2024 | Attendance confirmation table 3 |
| . . . | . . . |
| 6:00 p.m. on Oct. 15, 2024 | Attendance confirmation table 19 |

Since the attendance confirmation tables generated at the first time interval are stored in the attendance history database 116 as described above, the manager may monitor whether the employees normally go to work, leave work, or are in the workplace during work hours by confirming the attendance confirmation table for each time stored in the attendance history database 116.

According to an exemplary embodiment of the present disclosure, the management server 110 may further include an attendance report event generator 117, a first table extractor 118, and an attendance information reporter 119.

When a preset second time elapses from the work start time, the attendance report event generator 117 generates an attendance report event for reporting attendance state information to the manager.

In this regard, as in the above-described example, when the work start time is rt event generator 117 generates an attendance report event for reporting attendance state information to the manager.mally go to work, leave work, ttendance state information to the manager when “9:20 a.m.” is reached.

When the attendance report event is generated, the first table extractor 118 sorts attendance confirmation tables having date information which is the same as date information at a time point when the attendance report event is generated in the attendance history database 116, and then extracts a first attendance confirmation table having earliest time information among the sorted attendance confirmation tables.

In this regard, when a date at the time point when the attendance report event is generated is “Oct. 15, 2024”, the first table extractor 118 may sort attendance confirmation tables having date information which is the same as date information of “Oct. 15, 2024” in the attendance history database 116, and then extract a first attendance confirmation table having earliest time information among the sorted attendance confirmation tables. In this regard, when the attendance history database 116 is configured as shown in Table 3 above, the first table extractor 118 may extract “attendance confirmation table 1” as the first attendance confirmation table.

The attendance information reporter 119 transmits the first attendance confirmation table to the manager terminal 20 held by the manager.

This allows the manager to monitor attendance statuses of employees in the workplace by confirming the first attendance confirmation table.

Further, according to an exemplary embodiment of the present disclosure, the management server 110 may further include a leaving-work report event generator 120, a second table extractor 121, and a leaving-work information reporter 122.

When the second time elapses from the work end time, the attendance report event generator 120 generates a leaving-work report event for reporting leaving-work state information to the manager.

In this regard, as in the above-described example, when the work end time is ent generator 120 generates a leaving-work report event for reporting leaving-work state informatgenerate the leaving-work report event for reporting the leaving-work state information to the manager when “6:20 p.m.” is reached.

When the leaving-work report event is generated, the second table extractor 121 confirms attendance confirmation tables having date information which is the same as date information at a time point when the leaving-work report event is generated in the attendance history database 116 when the leaving-work report event is generated, and then extracts a second attendance confirmation table having latest time information among the confirmed attendance confirmation tables.

In this regard, when a date at the time point when the leaving-work report event is generated is ce confirmation tables having date information which is the samendance confirmation tables having date information which is the same as date information of “Oct. 15, 2024” in the attendance history database 116, and then extract a second attendance confirmation table having latest time information among the sorted attendance confirmation tables. In this regard, when the attendance history database 116 is configured as shown in Table 3 above, the second table extractor 121 may extract “attendance confirmation table 19” as the second attendance confirmation table.

The leaving-work information reporter 122 transmits the second attendance confirmation table to the manager terminal 20.

This allows the manager to confirm the second attendance confirmation table to perform leaving-work status monitoring, such as confirming that employees have not left work early in the workplace before a leaving-work time.

According to an exemplary embodiment of the present disclosure, the management server 110 may further include a query messaged transmitter 123, an extraction event generator 124, a detector 125, a grouping part 126, and an attendance information transmitter 127.

When the second attendance confirmation table is transmitted to the manager terminal 20, the query message transmitter 123 transmits a query message for querying whether poor attendance employee information is received to the manager terminal 20.

Then, the manager may view the query message received by the manager terminal 20 and determine whether the poor attendance employee information is to be received, and when determining to receive the poor attendance employee information, the manager may transmit a request instruction for providing the poor attendance employee information to the management server 110 of the present disclosure through the manager terminal 20.

The extraction event generator 124 generates an extraction event for extracting the poor attendance employee information when a providing request instruction of the poor attendance employee information is received in response to the query message from the manager terminal 20.

The detector 125 extracts all attendance confirmation tables having date information which is the same as the date information at a time point when the extraction event is generated in the attendance history database 116 when the extraction event is generated, and then detects employee identification information of which histories are omitted a preset first number of times as a poor attendance employee candidate group in the extracted attendance confirmation tables among the employee identification information of the plurality of employees.

In this regard, when a date at a time point when the extraction event is generated is “n this regard, when a date at a time point when the extraction event is generated is hich is the same as tmation table 2, attendance confirmation table 3, . . . , attendance confirmation table 19” which are the attendance confirmation tables having the date information which is the same as the date information of “Oct. 15, 2024” from the attendance history database 116 shown in Table 2 above.

In this case, when the first number of times is the extraction event is generated is hich is the same as tmation table 2, attendance confirmation table 3, . . . , attendance confirmation table 19″ which are the attendance confin “attendance confirmation table 1, attendance confirmation table 2, attendance confirmation table 3, . . . , attendance confirmation table 19” among the employee identification information of the plurality of employees.

For example, when the history of er ofoyee identification information 1″ is omitted in “attendance confirmation table 3, attendance confirmation table 4, attendance confirmation table 6, attendance confirmation table 7, and attendance confirmation table 8”, the detector 125 may configure the poor attendance employee candidate group in such a scheme that “employee identification information 1” is included in the poor attendance employee candidate group.

The grouping part 126 lists the extracted attendance confirmation tables in ascending order with respect to times corresponding to the respective tables when the detection of the poor attendance employee candidate group is completed, and then groups, among the employee identification information belonging to the poor attendance employee candidate group, employee identification information of which histories are continuously omitted a preset second number of times or more into a main poor attendance employee group in attendance confirmation tables listed in ascending order, and groups remaining employee identification information into an additional poor attendance employee group. In this regard, as in the above-described example, when the extracted attendance confirmation tables are e above-described example, when the extracted attendance confirmatattendance confirmation table 3, . . . , attendance confirmation table 19″, the grouping part 126 may list the “attention confirmation table 1, attendance confirmation table 2, attendance confirmation table 3, . . . attendance confirmation table 19” in ascending order of times corresponding to the respective tables.

In this case, when the second number of times is, when the extracted attendance confirmatattendance confirmation table 3, . . . , attendance confirmation table 19″, the grouping part 126 may list the “atteconfirmation table 1, attendance confirmation table 2, attendance confirmation table 3, . . . , attendance confirmation table 19” among the employee identification information belonging to the poor attendance employee candidate group into the main poor attendance employee group, and group remaining employee identification information into an additional poor attendance employee group.

For example, when the second number of times is, when the extracted attendance confirmatattendance confirmation table 3, . . . , attidentification information 1″ is employee identification information in which the history is continuously omitted “3 times” or more such as “attendance confirmation table 6, attendance confirmation table 7, and attendance confirmation table 8”, the grouping part 126 may configure the main poor attendance employee group in such a scheme that “employee identification information 1” is included in the main poor attendance employee group. On the other hand, when “employee identification information 5” belongs to the poor attendance employee candidate group, and “employee identification information 5” is employee identification information of which histories are continuously omitted “12 times” or more such as “attendance confirmation table 5, attendance confirmation table 8, attendance confirmation table 10, attendance confirmation table 12, and attendance confirmation table 13”, the grouping part 126 may configure the additional poor attendance employee candidate group in such a scheme that “employee identification information 5” is included in the additional poor attendance employee group.

When the configurations of the main poor attendance employee group and the additional poor attendance employee group are completed as described above, the attendance information transmitter 127 transmits information on the main poor attendance employee group and the additional poor attendance employee group to the manager terminal 20.

In this way, the manager may confirm which employees who leave the workplace are a specific number of times or more, and at the same time, also confirm which main poor attendance employees have left the workplace continuously a specific number of times or more.

According to an exemplary embodiment of the present disclosure, the management server 110 may further include a component that performs device mutual authentication with the wireless router equipment 10 in order to maintain security when acquiring the device identification information of the electronic terminals connected to the wireless router equipment 10 from the wireless router equipment as the acquisition event is generated by the acquisition event generator 112.

In this regard, the confirmer 113 may include an aggregation storage 128, a hash function storage 129, an authentication event generator 130, an encryption key generator 131, an encryption transmitter 132, an authenticator 133, and a confirmation processor 134.

The aggregation storage 128 stores a natural number aggregation which is pre-shared with the wireless router equipment 10. The natural number aggregation which means an aggregation constituted by five or more different natural numbers, and may be configured as “{1, 4, 20, 21, 64, 73}”.

The hash function storage 129 stores a hash function which is pre-shared with the wireless router equipment 10.

The authentication event generator 130 generates an authentication event for performing mutual authentication with the wireless router equipment 10 before acquiring the device identification information of the electronic terminals connected to the wireless router equipment 10 from the wireless router equipment 10 when the acquisition event is generated by the acquisition event generator 112 at any one time point.

When the authentication event is generated, the encryption key generator 131 sorts natural numbers included in the natural number aggregation in ascending order, calculates a first quartile, a median value, and a third quartile from the sorted natural numbers, and then applies an L1 norm of a vector having the first quartile, the median value, and the third quartile as components to the hash function as an input to the hash function to generate an encryption key.

Here, the quartile is obtained by dividing data sorted in ascending order into four equal parts, and the first quartile means a variation value corresponding to a ¼ position, the median value means a variation value corresponds to a ½ position, and the third quartile means a variation value corresponding to a ¾ position. In addition, the L1 norm means a value acquired by summing absolute values of respective components constituting the vector.

In this regard, when the first quartile is calculated as “a”, the median value is calculated as “b”, and the third quartile is calculate as “c”, the encryption key generator 131 may calculate an L1 norm of “[a b c]” which is a vector having “a”, “b”, and “c” as components, and then calculate a hash value by applying the calculated L1 norm as the input to the hash function to generate the calculated hash value with the encryption key.

The encryption transmitter 132 randomly extracts a first natural number which is any one of the natural numbers included in the natural number aggregation, generates an encryption value by encrypting the first natural number with the encryption key, and then transmits a reply instruction for instructing the wireless router equipment 10 to reply a decryption value for the encryption value while transmitting the encryption value to the wireless router equipment 10.

In this case, according to an exemplary embodiment of the present disclosure, upon receiving the reply instruction from the management server 110 of the present disclosure together with the encryption value, the wireless router equipment 10 may sort the natural numbers included in the natural number aggregation stored in the wireless router equipment 10 in ascending order, calculate the first quartile, the median value, and the third quartile from the sorted natural numbers, apply an L1 norm of a vector having the first quartile, the median value, and the third quartile as components to the hash function stored in the wireless router equipment 10 as the input to the hash function to generate the encryption key, decrypt the encryption value based on the encryption key to generate the first decryption value, and reply the first decryption value to the management server 110.

In this way, in response to the reply instruction from the wireless router equipment 10, when the first decryption value is received by the management server 110 of the present disclosure, the authenticator 133 confirms whether the first decryption value matches the first natural number, and when it is confirmed that the first decryption value matches the first natural number, the authenticator 133 completes mutual authentication with the wireless router equipment 10.

In this way, when the mutual authentication with the wireless router equipment 10 is completed, the confirmation processor 134 may acquire device identification information of electronic terminals connected to the wireless router equipment 10 from the wireless router equipment 10, and then confirm whether there is the device identification information matching the device identification information acquired from the wireless router equipment 10 among the device identification information of the electronic terminals of the plurality of employees.

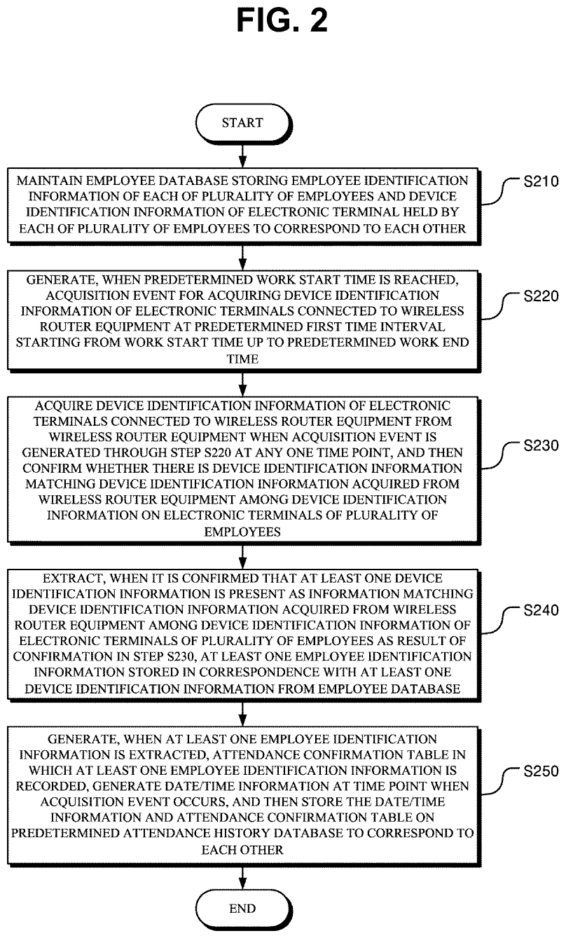

FIG. 2 is a flowchart illustrating an operating method of a management server that performs attendance management of an employee by linking with a wireless router equipment connected to a network according to an exemplary embodiment of the present disclosure.

In step S210, an employee database is maintained, which stores employee identification information of each of a plurality of employees and device identification information of the electronic terminal held by each of the plurality of employees in correspondence with each other.

In step S220, when a predetermined work start time is reached, an acquisition event for acquiring device identification information of electronic terminals connected to the wireless router equipment is generated at a predetermined first time interval starting from the work start time up to a predetermined work end time.

In step S230, the device identification information of the electronic terminals connected to the wireless router equipment is acquired from the wireless router equipment when the acquisition event occurs through step S220 at any one time point, and then it is confirmed whether there is device identification information matching the device identification information acquired from the wireless router equipment among the device identification information on the electronic terminals of the plurality of employees.

In step S240, when it is confirmed that at least one device identification information is present as information matching the device identification information acquired from the wireless router equipment 10 among the device identification information of the electronic terminals of the plurality of employees as a result of the confirmation in step S230, the at least one employee identification information stored in correspondence with the at least one device identification information is extracted from the employee database.

In step S250, when the at least one employee identification information is extracted, an attendance confirmation table in which the at least one employee identification information is recorded is generated, date/time information at time point when the acquisition event is generated is generated, and then the date/time information and the attendance confirmation table are stored to correspond to each other on a predetermined attendance history database.

In this case, according to an exemplary embodiment of the present disclosure, the operating method of the management server may further include: generating, when a preset second time elapses from the work start time, an attendance report event for reporting attendance state information to a manager; sorting, when the attendance report event is generated, attendance confirmation tables having date information which is the same as date information at a time point when the attendance report event is generated in the attendance history database, and then extracting a first attendance confirmation table having earliest time information among the sorted attendance confirmation tables; and transmitting the first attendance confirmation table to a manager terminal held by the manager.

Further, according to an exemplary embodiment of the present disclosure, the operating method of the management server may further include: generating, when the second time elapses from the work end time, a leaving-work report event for reporting leaving-work state information to the manager; sorting, when the leaving-work report event is generated, attendance confirmation tables having date information which is the same as date information at a time point when the leaving-work report event is generated in the attendance history database, and then extracting a second attendance confirmation table having latest time information among the sorted attendance confirmation tables; and transmitting the second attendance confirmation table to the manager terminal.

In this case, according to an exemplary embodiment of the present disclosure, the operating method of the management server may further include: transmitting, when the second attendance confirmation table is transmitted to the manager terminal, a query message for querying whether poor attendance employee information is received to the manager terminal; generating an extraction event for extracting the poor attendance employee information when a providing request instruction of the poor attendance employee information is received in response to the query message from the manager terminal; extracting all attendance confirmation tables having date information which is the same as the date information at the time point when the extraction event is generated from the attendance history database when the extraction event is generated, and then detecting employee identification information of which histories are omitted a preset first number of times as a poor attendance employee candidate group in the extracted attendance confirmation tables among the employee identification information of the plurality of employees; listing the extracted attendance confirmation tables in ascending order with respect to times corresponding to the respective tables when the detection of the poor attendance employee candidate group is completed, and then grouping, among the employee identification information belonging to the poor attendance employee candidate group, employee identification information of which histories are continuously omitted a preset second number of times or more into a main poor attendance employee group in attendance confirmation tables listed in ascending order, and grouping remaining employee identification information into an additional poor attendance employee group; and transmitting, to the manager terminal, information on the main poor attendance employee group and the additional poor attendance employee group.

Further, according to an exemplary embodiment of the present disclosure, step S230 may include: maintaining an aggregation storage storing a natural number aggregation which is pre-shared with the wireless router equipment (the natural number aggregation is an aggregation constituted by five or more different natural numbers); maintaining a hash function storage storing a hash function which is pre-shared with the wireless router equipment; generating an authentication event for performing mutual authentication with the wireless router equipment before acquiring the device identification information of the electronic terminals connected to the wireless router equipment from the wireless router equipment when the acquisition event is generated at any one time point through step S220; sorting, when the authentication event is generated, natural numbers included in the natural number aggregation in ascending order, calculating a first quartile, a median value, and a third quartile from the sorted natural numbers, and then applying an L1 norm of a vector having the first quartile, the median value, and the third quartile as components to the hash function as an input to the hash function to generate an encryption key; randomly extracting a first natural number which is any one of the natural numbers included in the natural number aggregation, generating an encryption value by encrypting the first natural number with the encryption key, and then transmitting a reply instruction for instructing to reply a decryption value for the encryption value to the wireless router equipment while transmitting the encryption value to the wireless router equipment; confirming, when a first decryption value is received from the wireless router equipment in response to the reply instruction, whether the first decryption value matches the first natural number, and when it is confirmed that the first decryption value matches the first natural number, completing mutual authentication with the wireless router equipment; and acquiring, when the mutual authentication with the wireless router equipment is completed, acquiring device identification information of electronic terminals connected to the wireless router equipment from the wireless router equipment, and then confirming whether there is the device identification information matching the device identification information acquired from the wireless router equipment among the device identification information of the electronic terminals of the plurality of employees.

In this case, upon receiving the reply instruction together with the encryption value, the wireless router equipment may sort the natural numbers included in the natural number aggregation stored in the wireless router equipment in ascending order, calculate the first quartile, the median value, and the third quartile from the sorted natural numbers, apply an L1 norm of a vector having the first quartile, the median value, and the third quartile as components to the hash function stored in the wireless router equipment as the input to the hash function to generate the encryption key, decrypt the encryption value based on the encryption key to generate the first decryption value, and reply the first decryption value to the management server.

Hereinabove, referring to FIG. 2, the operating method of the management server according to an exemplary embodiment of the present disclosure is described. Here, since the operating method of the management server according to an exemplary embodiment of the present disclosure may correspond to the configuration of the operation of the management server 110 described by using FIG. 1, a more detailed description thereof will be omitted.

The operating method of the management server according to an exemplary embodiment of the present disclosure may be implemented by a computer program stored in a storage medium for executing the computer program through coupling with a computer.

Further, the operating method of the management server according to an exemplary embodiment of the present disclosure may be implemented in a program command type which may be performed through various computer means and recorded in a computer readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all which are equivalent to the claims or equivalently modified are included in the scope of the present disclosure.

What is claimed is:

1. A management server that performs employee attendance management by linking with wireless router equipment connected to a network, the management server comprising:
an employee database storing employee identification information of each of a plurality of employees and device identification information of an electronic terminal held by each of the plurality of employees to correspond to each other;
an acquisition event generator generating, when a predetermined work start time is reached, an acquisition event for acquiring device identification information of electronic terminals connected to the wireless router equipment at a predetermined first time interval starting from the work start time up to a predetermined work end time;
a confirmer acquiring the device identification information of the electronic terminals connected to the wireless router equipment from the wireless router equipment when the acquisition event is generated through the acquisition event generator at any one time point, and then confirming whether there is device identification information matching the device identification information acquired from the wireless router equipment among the device identification information on the electronic terminals of the plurality of employees;
an extractor extracting, when it is confirmed that at least one device identification information is present as information matching the device identification information acquired from the wireless router equipment among the device identification information of the electronic terminals of the plurality of employees as a result of the confirmation by the confirmer, at least one employee identification information stored in correspondence with the at least one device identification information from the employee database; and
an information storage processor generating, when the at least one employee identification information is extracted, an attendance confirmation table in which the at least one employee identification information is recorded, generating date/time information at time point when the acquisition event occurs, and then storing the date/time information and the attendance confirmation table on a predetermined attendance history database to correspond to each other.

2. The management server of claim 1, further comprising:
an attendance report event generator generating, when a preset second time elapses from the work start time, an attendance report event for reporting attendance state information to a manager;
a first table extractor sorting, when the attendance report event is generated, attendance confirmation tables having date information which is the same as date information at a time point when the attendance report event is generated in the attendance history database, and then extracting a first attendance confirmation table having earliest time information among the sorted attendance confirmation tables; and
an attendance information reporter transmitting the first attendance confirmation table to a manager terminal held by the manager.

3. The management server of claim 2, further comprising:
a leaving-work report event generator generating, when the second time elapses from the work end time, a leaving-work report event for reporting leaving-work state information to the manager;
a second table extractor confirming, when the leaving-work report event is generated, attendance confirmation tables having date information which is the same as date information at a time point when the leaving-work report event is generated in the attendance history database, and then extracting a second attendance confirmation table having latest time information among the confirmed attendance confirmation tables; and
a leaving-work information reporter transmitting the second attendance confirmation table to the manager terminal.

4. The management server of claim 3, further comprising:
a query message transmitter transmitting, when the second attendance confirmation table is transmitted to the manager terminal, a query message for querying whether poor attendance employee information is received to the manager terminal;
an extraction event generator generating an extraction event for extracting the poor attendance employee information when a providing request instruction of the poor attendance employee information is received in response to the query message from the manager terminal;
a detector extracting all attendance confirmation tables having date information which is the same as the date information at the time point when the extraction event is generated from the attendance history database when the extraction event is generated, and then detecting employee identification information of which histories are omitted a preset first number of times as a poor attendance employee candidate group in the extracted attendance confirmation tables among the employee identification information of the plurality of employees;
a grouping part listing the extracted attendance confirmation tables in ascending order with respect to times corresponding to the respective tables when the detection of the poor attendance employee candidate group is completed, and then grouping, among the employee identification information belonging to the poor attendance employee candidate group, employee identification information of which histories are continuously omitted a preset second number of times or more into a main poor attendance employee group in attendance confirmation tables listed in ascending order, and grouping remaining employee identification information into an additional poor attendance employee group; and
an attendance information transmitter transmitting, to the manager terminal, information on the main poor attendance employee group and the additional poor attendance employee group.

5. The management server of claim 1, wherein the confirmer includes an aggregation storage storing a natural number aggregation which is pre-shared with the wireless router equipment, wherein the natural number aggregation is an aggregation constituted by five or more different natural numbers;
a hash function storage storing a hash function which is pre-shared with the wireless router equipment;
an authentication event generator generating an authentication event for performing mutual authentication with the wireless router equipment before acquiring the device identification information of the electronic terminals connected to the wireless router equipment from the wireless router equipment when the acquisition event is generated by the acquisition event generator at any one time point;
an encryption key generator sorting, when the authentication event is generated, natural numbers included in the natural number aggregation in ascending order, calculating a first quartile, a median value, and a third quartile from the sorted natural numbers, and then applying an L1 norm of a vector having the first quartile, the median value, and the third quartile as components to the hash function as an input to the hash function to generate an encryption key;
an encryption transmitter randomly extracting a first natural number which is any one of the natural numbers included in the natural number aggregation, generating an encryption value by encrypting the first natural number with the encryption key, and then transmitting a reply instruction for instructing to reply a decryption value for the encryption value to the wireless router equipment while transmitting the encryption value to the wireless router equipment;
an authenticator confirming, when a first decryption value is received from the wireless router equipment in response to the reply instruction, whether the first decryption value matches the first natural number, and when it is confirmed that the first decryption value matches the first natural number, completing mutual authentication with the wireless router equipment; and
a confirmation processor acquiring, when the mutual authentication with the wireless router equipment is completed, acquiring device identification information of electronic terminals connected to the wireless router equipment from the wireless router equipment, and then confirming whether there is the device identification information matching the device identification information acquired from the wireless router equipment among the device identification information of the electronic terminals of the plurality of employees,
wherein upon receiving the reply instruction together with the encryption value, the wireless router equipment sorts the natural numbers included in the natural number aggregation stored in the wireless router equipment in ascending order, calculates the first quartile, the median value, and the third quartile from the sorted natural numbers, applies an L1 norm of a vector having the first quartile, the median value, and the third quartile as components to the hash function stored in the wireless router equipment as the input to the hash function to generate the encryption key, decrypts the encryption value based on the encryption key to generate the first decryption value, and then replies the first decryption value to the management server.

6. An operating method of a management server that performs employee attendance management by linking with wireless router equipment connected to a network, the operating method comprising:
maintaining an employee database storing employee identification information of each of a plurality of employees and device identification information of an electronic terminal held by each of the plurality of employees to correspond to each other;
generating, when a predetermined work start time is reached, an acquisition event for acquiring device identification information of electronic terminals connected to the wireless router equipment at a predetermined first time interval starting from the work start time up to a predetermined work end time;
acquiring the device identification information of the electronic terminals connected to the wireless router equipment from the wireless router equipment when the acquisition event is generated through the generating of the acquisition event at any one time point, and then confirming whether there is device identification information matching the device identification information acquired from the wireless router equipment among the device identification information on the electronic terminals of the plurality of employees;
extracting, when it is confirmed that at least one device identification information is present as information matching the device identification information acquired from the wireless router equipment among the device identification information of the electronic terminals of the plurality of employees as a result of the confirmation in the confirming, at least one employee identification information stored in correspondence with the at least one device identification information from the employee database; and
generating, when the at least one employee identification information is extracted, an attendance confirmation table in which the at least one employee identification information is recorded, generating date/time information at time point when the acquisition event occurs, and then storing the date/time information and the attendance confirmation table on a predetermined attendance history database to correspond to each other.

7. The operating method of claim 6, further comprising:
generating, when a preset second time elapses from the work start time, an attendance report event for reporting attendance state information to a manager;
sorting, when the attendance report event is generated, attendance confirmation tables having date information which is the same as date information at a time point when the attendance report event is generated in the attendance history database, and then extracting a first attendance confirmation table having earliest time information among the sorted attendance confirmation tables; and
transmitting the first attendance confirmation table to a manager terminal held by the manager.

8. The operating method of claim 7, further comprising:
generating, when the second time elapses from the work end time, a leaving-work report event for reporting leaving-work state information to the manager;
sorting, when the leaving-work report event is generated, attendance confirmation tables having date information which is the same as date information at a time point when the leaving-work report event is generated in the attendance history database, and then extracting a second attendance confirmation table having latest time information among the sorted attendance confirmation tables; and
transmitting the second attendance confirmation table to the manager terminal.

9. The operating method of claim 8, further comprising:
transmitting, when the second attendance confirmation table is transmitted to the manager terminal, a query message for querying whether poor attendance employee information is received to the manager terminal;
generating an extraction event for extracting the poor attendance employee information when a providing request instruction of the poor attendance employee information is received in response to the query message from the manager terminal;
extracting all attendance confirmation tables having date information which is the same as the date information at the time point when the extraction event is generated from the attendance history database when the extraction event is generated, and then detecting employee identification information of which histories are omitted a preset first number of times as a poor attendance employee candidate group in the extracted attendance confirmation tables among the employee identification information of the plurality of employees;
listing the extracted attendance confirmation tables in ascending order with respect to times corresponding to the respective tables when the detection of the poor attendance employee candidate group is completed, and then grouping, among the employee identification information belonging to the poor attendance employee candidate group, employee identification information of which histories are continuously omitted a preset second number of times or more into a main poor attendance employee group in attendance confirmation tables listed in ascending order, and grouping remaining employee identification information into an additional poor attendance employee group; and
transmitting, to the manager terminal, information on the main poor attendance employee group and the additional poor attendance employee group.

10. The operating method of claim 6, wherein the acquiring includes maintaining an aggregation storage storing a natural number aggregation which is pre-shared with the wireless router equipment, wherein the natural number aggregation is an aggregation constituted by five or more different natural numbers;
maintaining a hash function storage storing a hash function which is pre-shared with the wireless router equipment;
generating an authentication event for performing mutual authentication with the wireless router equipment before acquiring the device identification information of the electronic terminals connected to the wireless router equipment from the wireless router equipment when the acquisition event is generated through the generating of the acquisition event at any one time point;
sorting, when the authentication event is generated, natural numbers included in the natural number aggregation in ascending order, calculating a first quartile, a median value, and a third quartile from the sorted natural numbers, and then applying an L1 norm of a vector having the first quartile, the median value, and the third quartile as components to the hash function as an input to the hash function to generate an encryption key;
randomly extracting a first natural number which is any one of the natural numbers included in the natural number aggregation, generating an encryption value by encrypting the first natural number with the encryption key, and then transmitting a reply instruction for instructing to reply a decryption value for the encryption value to the wireless router equipment while transmitting the encryption value to the wireless router equipment;
confirming, when a first decryption value is received from the wireless router equipment in response to the reply instruction, whether the first decryption value matches the first natural number, and when it is confirmed that the first decryption value matches the first natural number, completing mutual authentication with the wireless router equipment; and
acquiring, when the mutual authentication with the wireless router equipment is completed, acquiring device identification information of electronic terminals connected to the wireless router equipment from the wireless router equipment, and then confirming whether there is the device identification information matching the device identification information acquired from the wireless router equipment among the device identification information of the electronic terminals of the plurality of employees,
wherein upon receiving the reply instruction together with the encryption value, the wireless router equipment sorts the natural numbers included in the natural number aggregation stored in the wireless router equipment in ascending order, calculates the first quartile, the median value, and the third quartile from the sorted natural numbers, applies an L1 norm of a vector having the first quartile, the median value, and the third quartile as components to the hash function stored in the wireless router equipment as the input to the hash function to generate the encryption key, decrypts the encryption value based on the encryption key to generate the first decryption value, and replies the first decryption value to the management server.

11. A non-transitory computer readable recording medium having a program recorded therein for allowing a computer to execute an operating method of a management server that performs employee attendance management by linking with wireless router equipment connected to a network, the operating method comprising:
maintaining an employee database storing employee identification information of each of a plurality of employees and device identification information of an electronic terminal held by each of the plurality of employees to correspond to each other;
generating, when a predetermined work start time is reached, an acquisition event for acquiring device identification information of electronic terminals connected to the wireless router equipment at a predetermined first time interval starting from the work start time up to a predetermined work end time;
acquiring the device identification information of the electronic terminals connected to the wireless router equipment from the wireless router equipment when the acquisition event is generated through the generating of the acquisition event at any one time point, and then confirming whether there is device identification information matching the device identification information acquired from the wireless router equipment among the device identification information on the electronic terminals of the plurality of employees;
extracting, when it is confirmed that at least one device identification information is present as information matching the device identification information acquired from the wireless router equipment among the device identification information of the electronic terminals of the plurality of employees as a result of the confirmation in the confirming, at least one employee identification information stored in correspondence with the at least one device identification information from the employee database; and
generating, when the at least one employee identification information is extracted, an attendance confirmation table in which the at least one employee identification information is recorded, generating date/time information at time point when the acquisition event occurs, and then storing the date/time information and the attendance confirmation table on a predetermined attendance history database to correspond to each other.
